(19) United States
(12) Patent Application Publication
(10) Pub. No.: US 2009/0261030 A1
(43) Pub. Date: Oct. 22, 2009

(54) Storage and process container made up of an inner part and an outer part

(76) Inventor: Wilfried Hinxlage, Dinklage (DE)

Correspondence Address: COLLARD & ROE, P.C., 1077 NORTHERN BOULEVARD, ROSLYN, NY, 11576, US

(21) Appl. No.: 12/311,060

(22) PCT Filed: Sep. 19, 2006
(86) PCT No.: PCT/EP2006/066508

§ 371 Date: Apr. 10, 2009

(51) Int. Cl. B01D 29/05

(52) U.S. Cl. 210/251

(57) ABSTRACT

The invention relates to a storage and process container (1) which is made up of an inner part (I) and an outer part (A) and is intended for a drinks machine, a filter part (8) being arranged between the inner part (I) and the outer part (A). In order further to improve the quality of a container of the type in question, it is proposed that the filter part (8) be connected to the inner part (I) or to the outer part (A) directly by in-mould lamination.

The invention relates to a storage and process container for a drinks machine, made up of an inner part and an outer part, a filter part being disposed between the inner part and the outer part.

Containers of this kind are known and are used for example in drinks machines, such as further by way of example coffee machines. Coffee powder, for example, is stored initially in the container, which is formed as a throwaway part. After the container has been introduced into a drinks machine, in particular into a coffee machine, this container serves also in the course of the process as a brewing and filter container.

Starting from the state of the art specified, it is an object of the invention to provide a storage and process container of the kind in question in an advantageous manner, in particular in respect of production.

This objective is met first and foremost by the subject matter of claim 1, it being provided that-the filter part is bonded directly to the inner part or to the outer part by in-mould lamination on one side, while the side of the filter part which faces away from the inner part or from the outer part is free of plastics material of the in-mould lamination. As a result of this configuration, a secure and lasting bond is achieved between the filter part and the associated plastics moulded part. This bond is also not capable of being overcome in the course of the usual processes, such as for example the brewing-up of coffee. In addition, a bond is created, which is achieved over the entire contact area between the filter part and the associated plastics moulded part. Compared with known bonding techniques, such as for example ultrasound welding, in-mould lamination offers the possibility of a greater choice of material in respect of the filter part.

The subjects of the remaining claims are explained below with reference to the subject matter of claim 1, but may however also be of significance in their independent formulation.

Thus in an advantageous development of the subject matter of the invention, it is provided that the filter part is a non-woven material, thus further for example a paper non-woven material. It is also proposed in this regard that the filter part is a non-woven material formed as an annular disc having the same thickness all the way around, this further being preferably 0.01 to 0.1 mm, in addition by way of example 0.02, 0.03, 0.05, 0.07, or every additional fraction between 0.01 and 0.1 mm. A secure bond to the plastics moulded part and thereby also an arrangement offering a great filter area is provided by the in-mould lamination holding the filter part radially inwardly all the way around in the shape of a circle and radially outwardly all the way around in the shape of a circle, with in addition radially extending connecting webs. Accordingly stabilization of the annular non-woven filter is achieved, open filter areas being created between two neighbouring connecting webs in the circumferential direction and a web of a plastics part, the web running inwardly all the way around in the shape of a circle and outwardly all the way around in the shape of a circle.

The invention is explained in more detail below with reference to the drawing, which only shows one embodiment and in which:

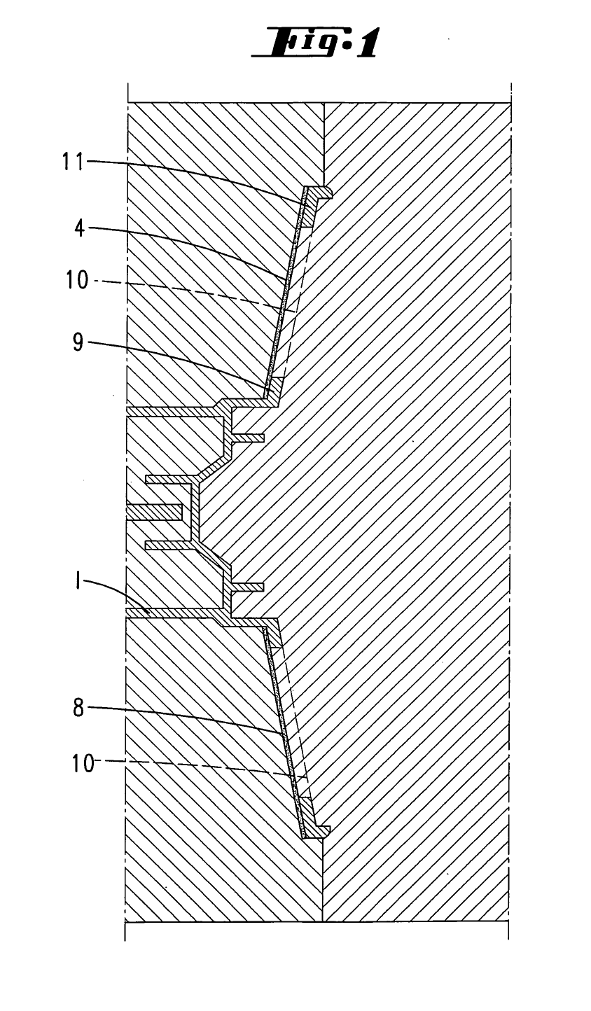

FIG. 1 shows a longitudinal section through a cavity for producing a one-trip storage and process container, which has an inserted, in-mould laminated filter part;

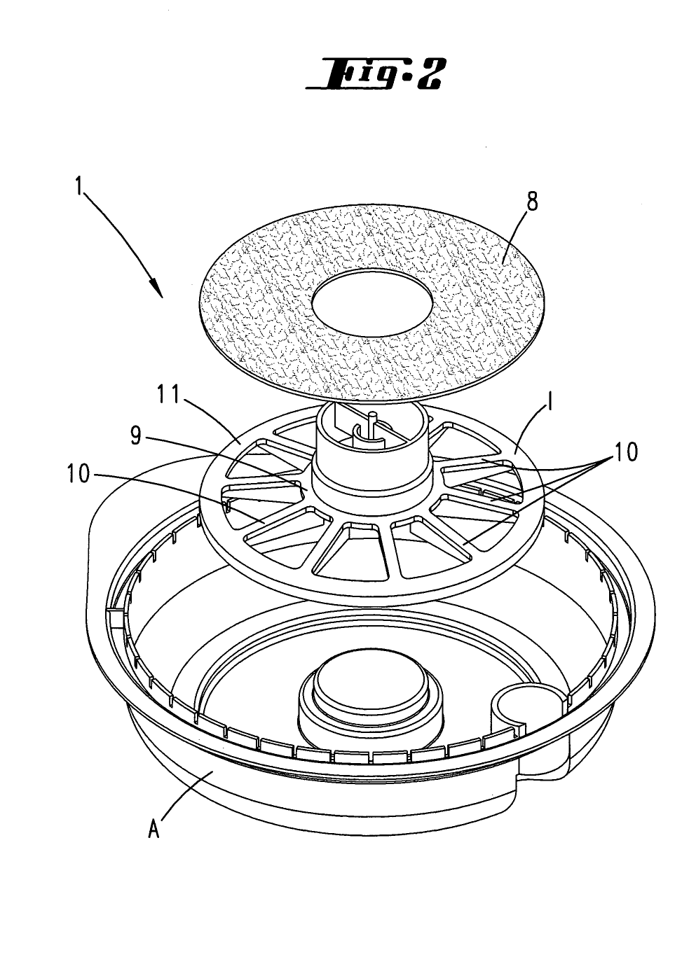

FIG. 2 shows, in a perspective exploded illustration, the outer part, the inner part without a filter part having been placed behind it, and a filter part which has not been subjected to in-mould lamination;

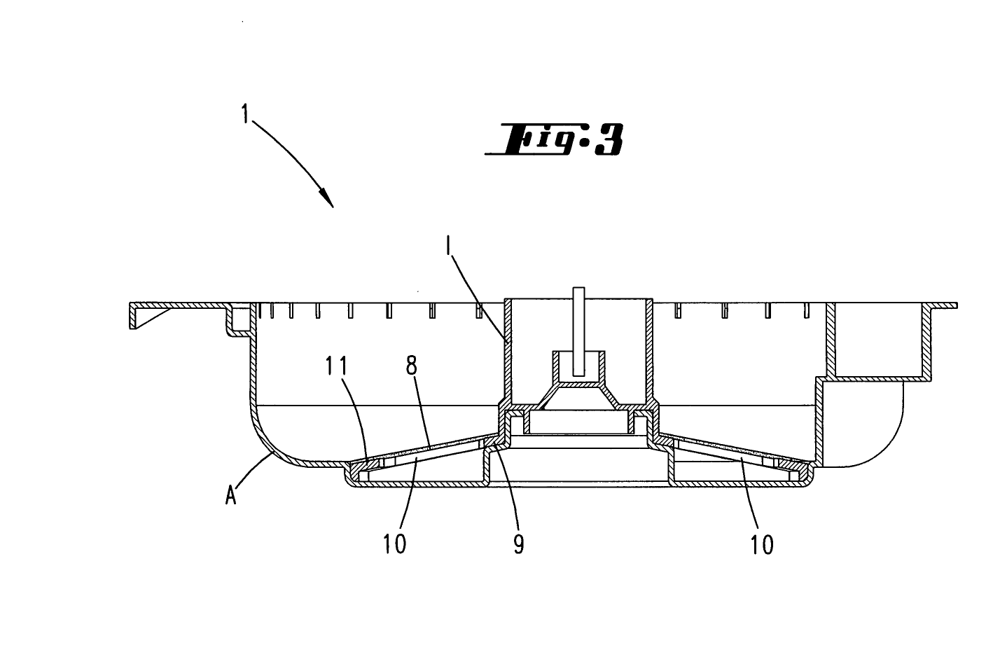

FIG. 3 shows the longitudinal section through an assembled storage and process container.

In order to produce a container 1, a filter part 8 is first of all stamped out at a separate station, not illustrated. This is a non-woven material having a thickness of about 0.03 mm and is formed as an annular disc having the same thickness all the way round. This filter part is inserted into a cavity 4.

The plastics material is injected into the cavity 4, whereby, in the cavity 4, in-mould lamination of the inserted filter part 8 is effected in the manner of an in-mould label (see FIG. 1). After this, the filter part 8, which is in the shape of an annular disc, is held, by the plastics material of the inner part I produced, both radial inwardly all the way around in the shape of a circle (inner ring 9) and also radial outwardly all the way around in the shape of a circle (outer ring 11). In addition, by virtue of the in-mould lamination, a bond is achieved between inner part I and filter part 8 in the regions of connecting webs 10, which link the radially inner ring 9 of the inner part I with the radially outer ring 11 of the same part. The connecting webs 10 are uniformly distributed over the circumference. In the exemplary embodiment shown, ten connecting webs 10 of this kind are provided.

In parallel with this this, an outer part A is separately moulded in another cavity. The cavities carrying the moulded parts throw out the inner part I and the outer part A in customary manner, after which assembly is carried out by inserting the inner part I provided with the filter part 8 into the outer part A.

By producing inner part I and outer part A in preferably the same time cycle, efficient production is made possible, this also assuring quality. As many inner parts I as outer parts A are produced at all times.

In FIG. 2, a container 1 accorded to the invention is shown in an exploded perspective view, a separated illustration of inner part I and filter part 8 being selected for simplification of representation. Obviously, the in-mould laminated filter part 8 cannot be removed from the inner part I without being destroyed. The container 1 shown in FIG. 3 in the assembled position in section serves for storing for example powder for a drink, such as for example coffee powder, for which purpose, the pot-shaped outer part A is in addition closed by a foil, but this is not illustrated. The container 1 thus prepared is inserted into a drinks machine and serves subsequently as a process container, whereby brewing up and filtering of the coffee powder is achieved by appropriate introduction of water.

All features disclosed are (in themselves) pertinent to the invention. The disclosure content of the associated/accompanying priority documents (copy of the prior application) is hereby also included in full in the disclosure of the application, also for the purpose of incorporating features of these documents in claims of the present application.

1. Storage and process container (1) for a drinks machine, made up of an inner part (I) and an outer part (A), a filter part (8) being disposed between the inner part (I) and the outer part (A), wherein the filter part (8) is bonded directly to the inner part (I) or to the outer part (A) by in-mould lamination on one side, while the side of the filter part (8) which faces the inner part or the outer part (A) is kept free of plastics material of the in-mould lamination.

2. Container according to claim 1, wherein the filter part (8) is a non-woven material.

3. Container according to claim 1, wherein the filter part (8) is a non-woven material formed as an annular disc with the same thickness all the way around.

4. Container according to claim 1, wherein the thickness of the filter part (8) is 0.01 to 0.1 mm.

5. Container according to claim 1, wherein the in-mould lamination holds the filter part (8) radially inwardly all the way around in the shape of a circle and radially outwardly all the way around in the shape of a circle, with in addition radially extending connecting webs (10).
